(19) United States
(12) Patent Application Publication
(10) Pub. No.: US 2016/0196037 A1
(43) Pub. Date: Jul. 7, 2016

(54) METHOD OF CONTROLLING USER INPUT AND APPARATUS TO WHICH THE METHOD IS APPLIED

(71) Applicant: Samsung Electronics Co., Ltd., Suwon-si (KR)

(72) Inventors: Suck-Ho Seo, Suwon-si (KR); Dong-Hyoun Son, Suwon-si (KR); Sang-Hyeok Sim, Suwon-si (KR); Ji-Ryang Chung, Suwon-si (KR); Il-Sung Hong, Seoul (KR)

(21) Appl. No.: 14/982,462

(22) Filed: Dec. 29, 2015

(30) Foreign Application Priority Data
Jan. 5, 2015 (KR) 10-2015-0000678

(51) Int. Cl. G06F 3/0481

(52) U.S. Cl. CPC G06F 3/04815

(57) ABSTRACT

A method of moving a pointer of an electronic device is provided. The method includes identifying a user input coordinates, identifying an object area corresponding to the user input coordinates, and actively moving and displaying the pointer in the object area using a contour map.

### CROSS-REFERENCE TO RELATED APPLICATION(S)

This application claims the benefit under 35 U.S.C. §119(a) of a Korean patent application filed on Jan. 5, 2015 in the Korean Intellectual Property Office and assigned Serial number 10-2015-0000678, the entire disclosure of which is hereby incorporated by reference.

### TECHNICAL FIELD

The present disclosure relates to a method and an apparatus for processing a user input.

### BACKGROUND

Various methods of processing a user input in an electronic device have been used. For example, a user input has been identified using a touch screen, or a user input has been identified through a user input device such as a remote controller. However, when the user input is identified through the user input device such as the remote controller, it is impossible to precisely control the area where a user wants to input a command.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for more precisely processing a user input.

In accordance with an aspect of the present disclosure, a method of moving a pointer of an electronic device is provided. The method includes identifying user input coordinates, identifying an object area corresponding to the user input coordinates, and actively moving and displaying the pointer in the object area using a contour map.

In accordance with another aspect of the present disclosure, an electronic device is provided. The device includes a display unit configured to display information, a user input detecting unit configured to detect a user input event which is input by a user, and a control unit configured to identify user input coordinates, identify an object area corresponding to the user input coordinates, and actively move and display the pointer in the object area using a contour map.

A user input can be more precisely processed.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart illustrating a sequence of a method of moving a pointer of an electronic device according to various embodiments of the present disclosure;

FIG. 2 is an example view of a user interface used in a method of moving a pointer of an electronic device according to various embodiments of the present disclosure;

FIGS. 3A and 3B are example views illustrating contour maps used in a method of moving a pointer of an electronic device according to various embodiments of the present disclosure;

FIGS. 4A and 4B are other example views illustrating contour maps used in a method of moving a pointer of an electronic device according to various embodiments of the present disclosure;

FIG. 5A is a view illustrating a user interface used in a method of moving a pointer of an electronic device according to various embodiments;

FIG. 5B is a view illustrating a contour map configured in consideration of an object included in the user interface of FIG. 5A;

FIG. 6 is a flowchart illustrating a sequence of a method of moving a pointer of an electronic device according to another embodiment of the present disclosure;

FIG. 7 is a first example view illustrating an operation of a method of moving a pointer of an electronic device according to another embodiment of the present disclosure;

FIG. 8 is a second example view illustrating an operation of a method of moving a pointer of an electronic device according to another embodiment of the present disclosure; and

FIG. 9 is a block diagram illustrating a configuration of an electronic device to which a method of moving a pointer according to various embodiments of the present disclosure is applied.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expression “a first”, “a second”, “the first”, or “the second” used in various embodiments of the present disclosure may modify various components regardless of the order and/or the importance but does not limit the corresponding components. The expressions may be used to distinguish a component element from another component element. For example, a first user device and a second user device may indicate different user devices regardless of the sequence or importance thereof. For example, a first element may be termed a second element, and similarly, a second element may be termed a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). Conversely, when it is mentioned that one element (e.g., a first element) is “directly coupled” or “directly connected” to another element (e.g., a second element), it may be construed that yet another element does not exist between the one element and the another element.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, the singular forms may include the plural forms as well, unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic accessory, electronic tattoos, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments of the present disclosure will be described with reference to the accompanying drawings. In the present disclosure, the term “user” may indicate a person using an electronic device or a device (e.g. an artificial intelligence electronic device) operating an electronic device.

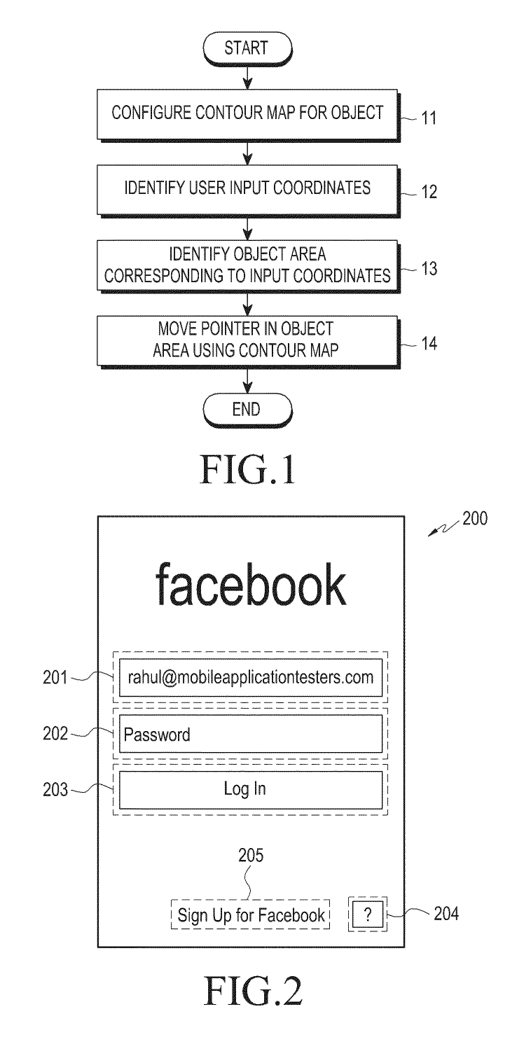

FIG. 1 is a flowchart illustrating a sequence of a method of moving a pointer of an electronic device according to various embodiments of the present disclosure. FIG. 2 is an example view of a user interface used in a method of moving a pointer of an electronic device according to various embodiments of the present disclosure.

Referring to FIG. 1, a method of moving a pointer of an electronic device according to various embodiments of the present disclosure may include configuring a contour map for an object included in a screen at operation 11, identifying a user input coordinates at operation 12, identifying an object area corresponding to the user input coordinates at operation 13, and actively moving and displaying the pointer in the object area using a contour map at operation 14.

First, operation 11 may include identifying each object in the user interface and configuring the contour map for the objects. For example, referring to FIG. 2, which exemplifies a user interface, a user interface 200 may include a plurality of objects 201, 202, 203, 204 and 205. Positions, sizes, attributes and the like of the objects 201, 202, 203, 204 and 205 included in the user interface as described above may be configured in a process of designing an application. Therefore, in operation 11, an area where the object is located may be identified based on the positions, the sizes, the attributes and the like of each of the objects 201, 202, 203, 204 and 205 included in the user interface 200. Next, a contour map for the identified object may be configured. Furthermore, the attributes for the object may be reflected in configuring the contour map. For example, when the object in the user interface 200 is an object having a text input attribute like the first object 201 and the second object 202, the contour map may be configured such that an area where initially a text is input in the first and second objects 201 and 202 has comparatively the lowest height. As another example, when the object in the user interface 200 is an object having a button input attribute like the third object 203 and the fourth object 204, the contour map may be configured such that a central area of the third and fourth objects 203 and 204 has comparatively the lowest height. In addition, as another example, when the object in the user interface 200 is an object having an external link input attribute like the fifth object 205, the contour map may be configured such that a central area of the fifth object 205 has comparatively the lowest height.

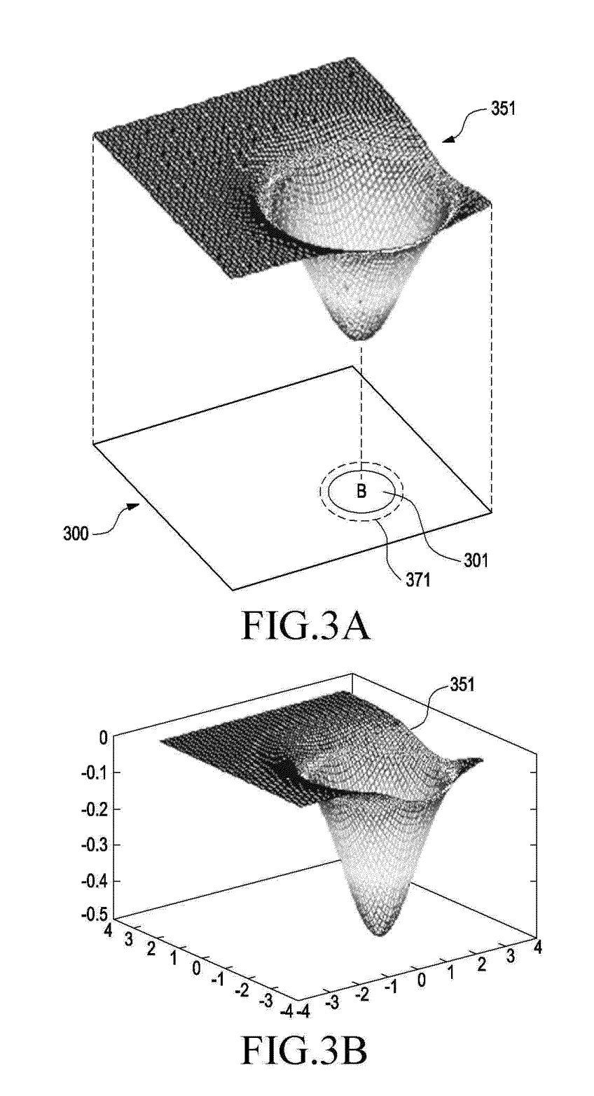

FIGS. 3A and 3B are example views illustrating contour maps used in a method of moving a pointer of an electronic device according to various embodiments of the present disclosure.

Referring to FIGS. 3A and 3B, an object 301 is included in an area 300 of a user interface. The area having a predetermined size based on the object 301 may be configured as the area 300 where the object is included. In addition, a contour map 351 for the object 301 in the area 300 may be configured. Specifically, the contour map 351 may be configured such that a central area of the object 301 has the lowest contour value. The contour map 351 may be formed such that a contour difference (e.g., a slope) of a perimeter area around the area where the object is included is relatively low, and a contour difference (e.g., a slope) of an area 371 where the object 301 is displayed is relatively high.

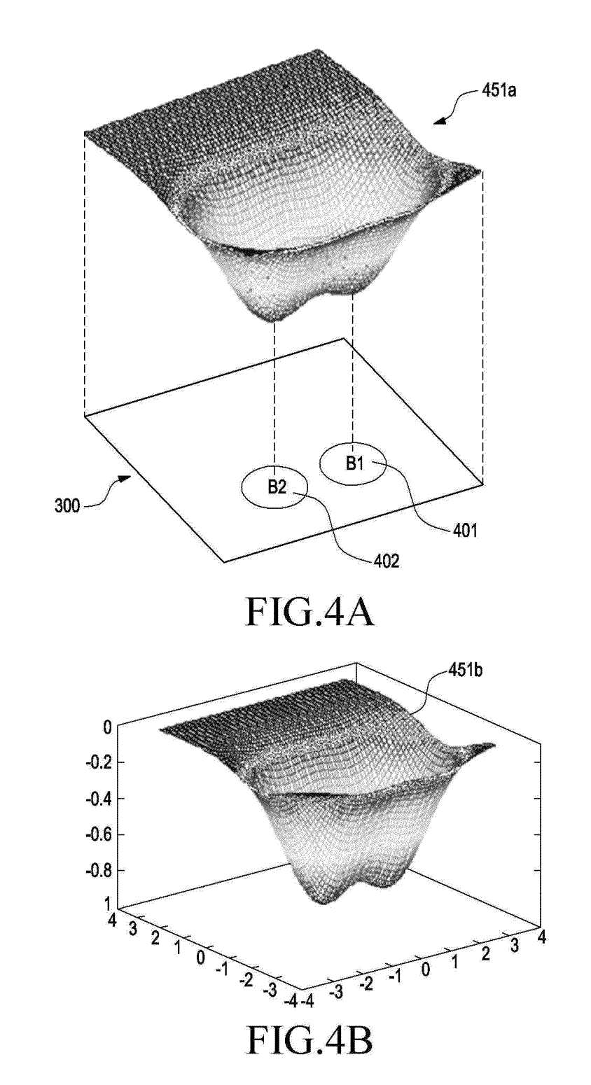

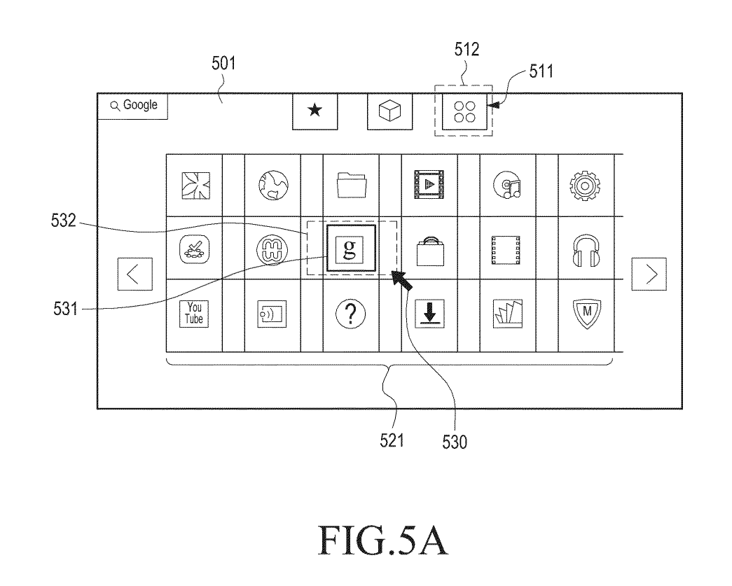

FIGS. 4A and 4B are other example views illustrating contour maps used in a method of moving a pointer of an electronic device according to various embodiments of the present disclosure.

Referring to FIG. 4A, a plurality of objects 401 is included in an area 400 of a user interface. The area having a predetermined size based on a first object B1 401 and a second object B2 402 may be configured as the area 400 where the object is included. In addition, a contour map 451a for the first object B1 401 and the second object B2 402 in the area 400 may be configured. The contour map 451a may be configured such that central areas of the first object B1 401 and the second object B2 402 have the lowest contour value. In addition, when the plurality of objects B1 401 and B2 402 such as the first and second objects B1 401 and B2 402 is included in the area 400, a height of the contour map may be configured according to a comparative density. As described above, a map of which a height is configured according to a comparative density of the plurality of objects B1 401 and B2 402 is referred to as a comparative density map. The comparative density map may be configured in consideration of at least one of an attribute of the object, a position of the object, an existence-or-not of an object adjacent to the object, a distance between a plurality of objects, and the size of the object. For example, as shown in FIG. 4B, the contour map 451 corresponding to the first and second objects 401 and 402 may be configured. In this way, a depth of the contour map 451b for the first and second objects 401 and 402 may be configured such that the depth of the contour map 451b for the first and second objects 401 and 402 may have a lower depth value compared to a time when a single object exists.

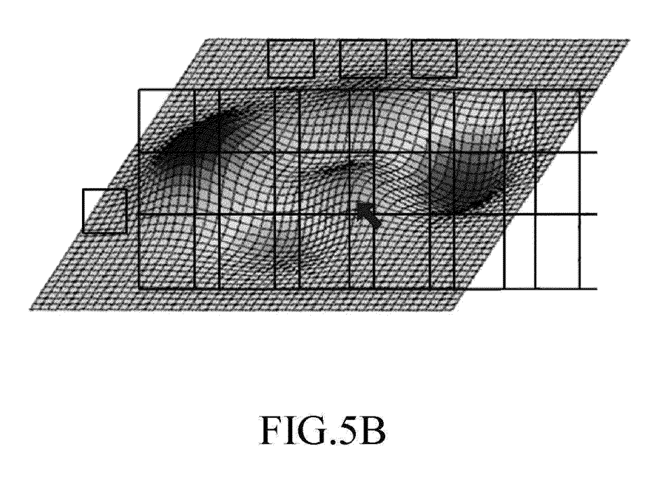

FIG. 5A is a view illustrating a user interface used in a method of moving a pointer of an electronic device according to various embodiments. FIG. 5B is a view illustrating a contour map configured in consideration of an object included in a user interface.

Through the above-mentioned operation 11, a coordinates range 512 where at least one object 511 in a user interface 501 is positioned may be identified, and a contour map may be configured correspondingly to the coordinates range 512 where the object is positioned. For example, the contour map may be configured such that the object 511 has a comparatively low contour value in a central area of the coordinates range 512 and has a comparatively high contour value in a perimeter area around of the coordinates range 512. In addition, when a plurality of objects 521 are in the user interface 501, a height of a contour may be configured according to a comparative density of the plurality of objects 521.

An operation of reconfiguring the above-mentioned contour map may be performed in a process of generating the user interface. As another example, when the user interface is an interface which may be changed or corrected by a user, the operation of reconfiguring the contour map may be performed in a process of changing or correcting the user interface by the user.

Furthermore, the configuring of the contour map for the user interface may be performed in a process of forming the user interface.

In addition, the contour map may be adaptively reconfigured by reflecting a user input. For example, the higher a frequency number of an area where an object selected by a user exists or an area where a selection of a user is input, the lower a contour value of the contour map for a corresponding area.

Meanwhile, when a user input is generated, the user input may be processed using the contour map. Specifically, in operation 12, coordinates of an area where a user input is generated may be identified. For example, when the user input is generated by a use of a touch screen of an electronic device, the electronic device may identify coordinates of an area where the user input is generated. As another example, when the user input is input through a remote controller and the like connected to an electronic device, the electronic device may display an indicator 530 of FIG. 5A (e.g., a cursor or a pointer) which can identify the user input through the remote controller and the like. When the indicator is not moved for a time equal to or more than a predetermined time, the electronic device may recognize that the user input is generated in a corresponding area, and may identify an area where the indicator is positioned as the coordinates of the area where the user input is generated. As another example, when the user input is input through a remote controller and the like connected to an electronic device, the electronic device may display an indicator 530 of FIG. 5A (e.g., a cursor or a pointer) which can identify the user input through the remote controller and the like. When an additional signal which instructs an input completion is input by the user, the electronic device may recognize that the user input is generated in a corresponding area and may identify an area where the indicator is positioned as the coordinates of the area where the user input is generated. For example, the electronic device may display the indicator 530 (e.g., cursor or pointer) which can identify the user input through the remote controller and the like to a display. When a button (e.g., an input button, a completion button, an OK button or the like) predetermined in advance by the user is input, the electronic device may recognize that the user input is generated in a corresponding area and may identify an area where the indicator is positioned as the coordinates of the area where the user input is generated.

In operation 13, an object area corresponding to the coordinates of the area where the user input is generated may be identified. The object area corresponding to the coordinates of the area where the user input is generated may be an area corresponding to a coordinates range in which at least one object is positioned.

In operation 14, the indicator 530 of FIG. 5A (e.g., cursor or pointer) which can identify the user input is moved using the contour map. For example, the indicator 530 may be moved to an area having a comparatively low height according to the contour map. A moving acceleration may be applied to the movement of the indicator according to a slope of the contour map.

For example, when the user input is generated in a first area 531, in operation 13 the coordinates range in which the object is positioned is identified as a first coordinates range 532. Next, in operation 14, the pointer is moved to the area having the comparatively low height according to the contour map of the first coordinates range 532.

Meanwhile, the user interface 501 may process an input which selects at least one displayed object. In addition, as another example, the user interface may provide a page including at least one object. The number of pages may be plural. Therefore, the user interface may move between the plurality of pages. For example, the user interface may divide the user input into a tap input and a flick input. When the user input is recognized as the tap input, the user interface may select an object corresponding to a corresponding area. In addition, when the user input is recognized as the flick input, the user interface may change a currently displayed page to another page to display the changed page. Hereinafter, in a method of moving a pointer of an electronic device according to another embodiment of the present disclosure, an operation process of a user interface supporting a click input and a flick input is described.

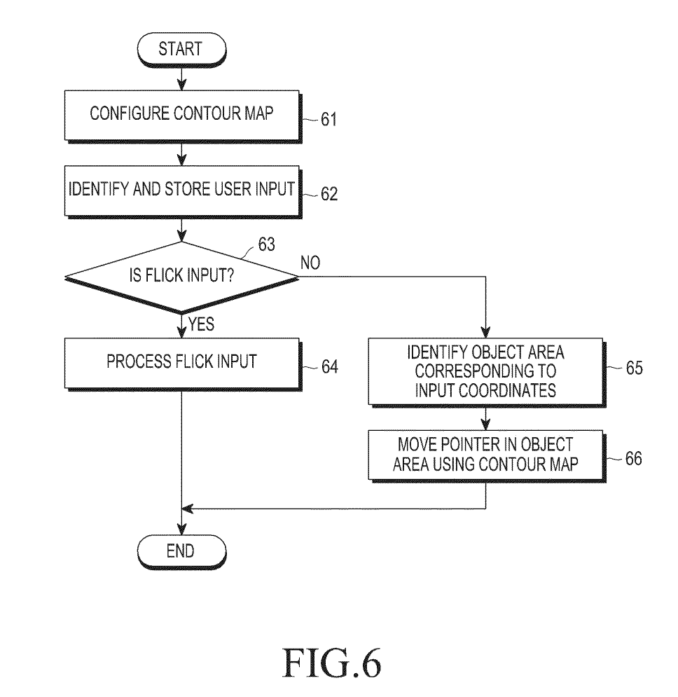

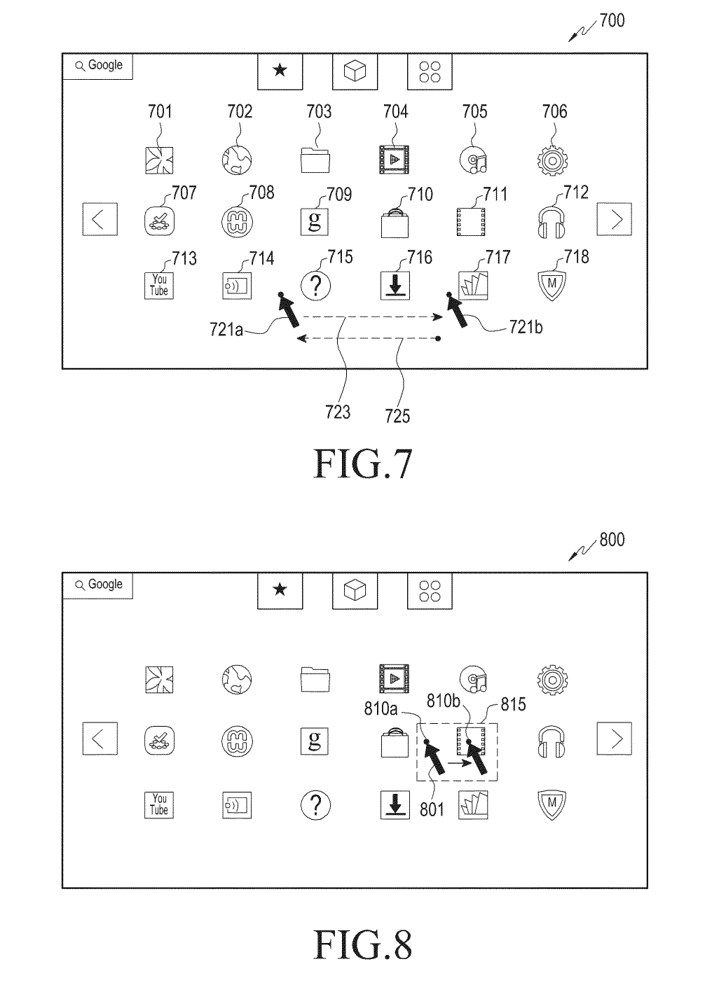

FIG. 6 is a flowchart illustrating a sequence of a method of moving a pointer of an electronic device according to another embodiment of the present disclosure. FIG. 7 is a first example view illustrating an operation of a method of moving a pointer of an electronic device according to another embodiment of the present disclosure. FIG. 8 is a second example view illustrating an operation of a method of moving a pointer of an electronic device according to another embodiment of the present disclosure.

Referring to FIG. 6, similarly to the above-mentioned operation 11, operation 61 may include identifying each object in a user interface and configuring a contour map for the objects. For example, referring to FIG. 7 which exemplifies the user interface, the user interface 700 of FIG. 7 may include a plurality of objects 701 to 718. Positions, sizes, attributes and the like of the objects 701 to 718 included in the user interface as described above may be configured in a process of designing an application. Therefore, in operation 61, an area where the object is located may be identified based on the positions, the sizes, the attributes and the like of each of the objects 701 to 718 included in the user interface 700. Next, a contour map for the identified object may be configured. Furthermore, the attributes for the object may be reflected in configuring the contour map.

Meanwhile, the user interface 700 may process various user inputs of a user. For example, the user input may include a tab input or a flick input. In addition, the electronic device may process various operations correspondingly to the user input.

In a method of moving a pointer of an electronic device according to another embodiment, a pointer may be moved correspondingly to the various user inputs. In operation 62, a generation of the user input is identified, and a coordinates in which the user input is generated is identified and stored.

In operation 63, a type of the user input is identified, and it is identified whether or not the user input is the flick input. When the user input is the flick input (i.e., 63—yes), operation 64 is performed. In operation 64, while the flick input is generated, the pointer 721a is moved to a point at operation 721b where the flick input is completed along a trajectory 723 of FIG. 7 of the user input. Next, when the flick input of the user input is completed, the pointer 721b is moved again along a trajectory 725, which is inverted to the trajectory 723 along which the user input is generated. According to an embodiment, the moving of the pointer 721b again along the trajectory 725, which is inverted to the user input trajectory 723, in a case of the completion of the flick input may be for preventing an unwanted position movement of the pointer 721a due to the flick input.

In addition, when the user input is not the flick input (i.e., 63—no), operation 65 is performed. In operation 65, the object area corresponding to the coordinates where the user input is generated is identified. The object area corresponding to the coordinates where the user input is generated may be an area corresponding to the coordinates range where at least one object is positioned.

Meanwhile, user interface 800 may also process various user inputs of a user.

In operation 66, an indicator 801, which can identify the user input, of FIG. 8 (e.g., a cursor or a pointer) is moved using the contour map. For example, the indicator 801 may be moved from an area 810a where the user input is generated to an area 810b having a comparatively low height according to the contour map. A moving acceleration may be applied to the indicator according to the contour map, and the indicator may be moved.

For example, when the user input is generated in the first area 810a, in operation 65, the coordinates range where the object is positioned is identified as a first coordinates range 815. Next, in operation 66, the pointer is moved to the area 810b having the comparatively low height according to the contour map of the first coordinates range 815.

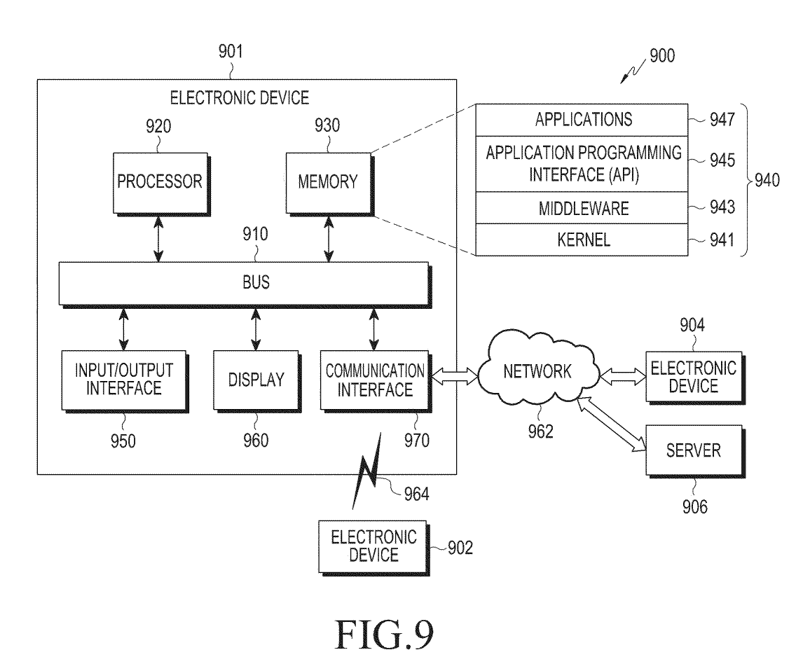

FIG. 9 is a block diagram illustrating a configuration of an electronic device to which a method of moving a pointer according to various embodiments of the present disclosure.

Referring to FIG. 9, an electronic device 901 in a network environment 900 is disclosed. The electronic device 901 may include a bus 910, a processor 920, a memory 930, an input/output interface 950, a display 960 and a communication interface 970. In an embodiment, the electronic device 901 may omit at least one of the elements or add another element.

For example, the bus 910 may connect above-mentioned elements 910 to 970 and include a circuit transferring a communication (e.g., a control message and/or data) among the elements.

The processor 920 may include at least one of a Central Processing Unit (CPU), an Application Processor (AP) and a Communication Processor (CP). For example, the processor 920 may execute a control of at least one of the other elements, a calculation related to a communication, and/or a data processing.

The memory 930 may include a volatile memory and/or a nonvolatile memory. For example, the memory 930 may store a command or data related to at least one of the other elements in the electronic device 901. According to an embodiment, the memory 930 may store a software and/or a program 140. For example, the program 940 may include a kernel 941, a middleware 943, an Application Programming Interface (API) 945, an application program (or an application) 947, and the like. At least some of the kernel 941, the middleware 943 and the API 945 may be referred to an Operating System (OS).

For example, the kernel 941 may control or manage system resources (e.g., the bus 910, the processor 920, the memory 930, etc.) used for executing an operation or a function implemented in other programs (e.g., the middle ware 943, the API 945, or the application program 947). Further, the kernel 941 may provide an interface that enables the middle ware 943, the API 945, or the application program 947 to access an individual component of the electronic device 901 to control or manage the system resources.

The middle ware 943 may function as a relay so that the API 945 or the application program 947 performs a communication with the kernel 941 to transmit and receive data to and from the kernel 941. Further, in relation to requests for operation received from the application program 947, the middleware 943 may control (e.g., scheduling or load-balancing) the requests by using, for example, a method of determining sequence using system resources (e.g., the bus 910, the processor 920, the memory 930, or the like) of the electronic device 901 with respect to at least one application among the application programs 947.

For example, the API 945 is an interface used by the application 947 to control a function provided from the kernel 941 or the middle ware 943, and may include, for example, at least one interface or function (e.g. a command) for a file control, a window control, an image processing, a character control, etc.

For example, the input/output interface 950 may function as an interface which may transfer a command or data input from a user or other external devices to the other element(s) of the electronic device 901. In addition, the input/output interface 950 may output the command or data received from the other element(s) of the electronic device 901 to the user or the other external devices.

For example, the display 960 may include, a Liquid Crystal Display (LCD), a Light Emitting Diode (LED) display, an Organic Light Emitting Diode (OLED) display, a MicroElectroMechanical Systems (MEMS) display, or an electronic paper display. For example, the display 960 may display various types of contents (e.g., a text, an image, a video, an icon, a symbol, or the like) to a user. The display 960 may include a touch screen and receive an input of a touch using an electronic pen or a portion of a body of a user, a gesture, a proximity, or a hovering.

For example, the communication interface 970 may configure a communication 964 between the electronic device 901 and an external electronic device (e.g., a first external electronic device 902, a second external electronic device 904 or the server 906). For example, the communication interface 970 may be connected to a network 962 through a wireless communication or a wired communication, and may communicate with the external device (e.g., the second electronic device 904 or the server 906).

For example, the wireless communication may use at least one of LTE, LTE-A, CDMA, WCDMA, UMTS, WiBro and GSM. The wired communication may include at least one of a Universal Serial Bus (USB), a High Definition Multimedia Interface (HDMI), Recommended Standard 232 (RS-232), and a Plain Old Telephone Service (POTS). The network 962 may include at least one of communication networks, for example, a computer network (e.g., LAN or WAN), an Internet and a telephone network.

Each of the first and second external electronic devices 102 and 104 may be equal to or different from the electronic device 901. According to an embodiment, the server 906 may include one or more groups of servers. According to various embodiments, all or some of operations executed in the electronic device 901 may be executed in another electronic device, or a plurality of other electronic devices (e.g., the electronic devices 902, 904 or the server 906). According to an embodiment, when the electronic device 901 should perform any function or service automatically or by a request, the electronic device 901 may request at least some functions related to the function or the service to the other device (e.g., the electronic device 902, the electronic device 904 or the server 906) instead the electronic device 901 executes the function or the service. Alternatively, the electronic device 901 may additionally request at least some functions related to the function or the service to the other electronic device (e.g., the electronic device 902, the electronic device 904 or the server 906). The other electronic device (e.g., the electronic device 902, the electronic device 904 or the server 906) may execute the requested function or the additional function and transfer a result of the execution to the electronic device 901. The electronic device 901 may process the received result by itself or in conjunction with the other electronic devices and provide the requested function or service. To this end, for example, a cloud computing, a distribution computing or a client-server computing technique may be used.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The module may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor 920), the one or more processors may execute a function corresponding to the command. The computer-readable storage medium may be, for example, the memory 930.

The computer readable recoding medium may include magnetic media, such as a hard disk, a floppy disk and a magnetic tape, optical media, such as a Compact Disc Read Only Memory (CD-ROM) and a Digital Versatile Disc (DVD), magneto-optical media, such as a floptical disk, and a hardware device specially configured to store and execute a program instruction (for example, a programming module), such as a Read Only Memory (ROM), a Random Access Memory (RAM), a flash memory, and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of moving a pointer of an electronic device, the method comprising:
identifying a user input coordinates;
identifying an object area corresponding to the user input coordinates; and
actively moving and displaying the pointer in the object area, using a contour map.

2. The method of claim 1, wherein the actively moving and displaying of the pointer includes moving the pointer to a central area of the object area and displaying the pointer.

3. The method of claim 1, further comprising:
configuring the contour map.

4. The method of claim 3, wherein the configuring of the contour map includes configuring a central area of the object area such that the central area of the object area is comparatively lower than a perimeter area of the object area.

5. The method of claim 3, wherein the configuring of the contour map includes reconfiguring the contour map by reflecting at least one of the user input coordinates, the object area corresponding to the user input coordinates, an input frequency number of the user input coordinates, and a selection frequency number of the object area.

6. The method of claim 1, wherein the actively moving and displaying of the pointer includes actively moving and displaying the pointer by reflecting a height of the contour map.

7. The method of claim 6, wherein the actively moving and displaying of the pointer includes configuring at least one of a moving speed of the pointer and a moving acceleration of the pointer by reflecting the height of the contour map.

8. The method of claim 3, wherein the actively moving and displaying of the pointer includes the height of the contour map configured to use a comparative density.

9. The method of claim 1, further comprising:
storing an initial user input coordinates;
identifying whether it is a first user input according to a change of the user input coordinates; and
displaying the movement of the pointer to the initial user input coordinates, according to the first user input.

10. The method of claim 1, further comprising:
storing an initial user input coordinates;
determining whether it is a first user input according to a change of the user input coordinates; and
deleting the initial user input coordinates if the first user input is not the first user input.

11. The method of claim 1, wherein the object area is configured by reflecting a size and an arrangement for at least one displayed icon.

12. An electronic device comprising:
a display unit configured to display information;
a user input detecting unit configured to detect a user input event which is input by a user; and
a control unit configured to:
identify user input coordinates,
identify an object area corresponding to the user input coordinates, and
actively move and display the pointer in the object area using a contour map.

13. The electronic device of claim 12, wherein the control unit is configured to move the pointer to a central area of the object area and display the pointer in consideration of the contour map.

14. The electronic device of claim 12, wherein the control unit is configured to configure the contour map for an object in a screen.

15. The electronic device of claim 14, wherein the control unit is configured to configure a contour value of a central area in the object area such that the contour value of the central area in the object area is comparatively lower than that of a perimeter area in the object area.

16. The electronic device of claim 14, wherein the control unit is configured to reconfigure the contour map by reflecting at least one of the user input coordinates, the object area corresponding to the user input coordinates, an input frequency number of the user input coordinates, and a selection frequency number of the object area.

17. The electronic device of claim 12, wherein the control unit is configured to actively move and display the pointer by reflecting a height of the contour map.

18. The electronic device of claim 12, wherein the control unit is configured to configure at least one of a moving speed of the pointer and a moving acceleration of the pointer by reflecting a height of the contour map.

19. The electronic device of claim 12, wherein the control unit is configured to store initial user input coordinates, identify whether it is a first user input according to a change of the user input coordinates, and display the movement of the pointer to the initial user input coordinates according to the first user input.

20. The electronic device of claim 12, wherein the control unit is configured to store initial user input coordinates, identify whether it is a first user input according to a change of the user input coordinates, and delete the initial user input coordinates based on a result of the identifying whether or not it is the first user input.
